(19) United States
(12) Patent Application Publication
(10) Pub. No.: US 2013/0129361 A1
(43) Pub. Date: May 23, 2013

(54) OPTICAL TRANSMITTER MODULE AND TRANSMITTING METHOD

(71) Applicant: YU-CHAO HSIAO, Tu-Cheng (TW)

(72) Inventor: YU-CHAO HSIAO, Tu-Cheng (TW)

(73) Assignee: HON HAI PRECISION INDUSTRY CO., LTD., Tu-Cheng (TW)

(21) Appl. No.: 13/535,773

(22) Filed: Jun. 28, 2012

(30) Foreign Application Priority Data
Nov. 22, 2011 (TW) 100142807

(51) Int. Cl. H04B 10/04

(52) U.S. Cl. 398/183

(57) ABSTRACT

An optical transmitter module includes at least one light source, at least one optical modulator aligned to the at least one light source one by one, a first light interleaver, and at least one optical fiber. Each light source emits a light wave with a particular wavelength. Each optical modulator modulates the light wave of the corresponding light source, to form a central light wave having the particular wavelength and a number of secondary light waves having secondary wavelengths. The first light interleaver separates the secondary light waves from the central light wave. The at least one optical fiber transmits the secondary light waves.

### BACKGROUND

1. Technical Field

The present disclosure relates to an optical communication system, especially relating to an optical transmitter module and an optical transmitting method using the optical transmitter.

2. Description of Related Art

An optical communication system usually has an optical transmitter module for transmitting optical signals. In the optical transmitter module, one light source corresponds to one carrier light wave. If multiple carrier waves are needed, the optical transmitter module must use corresponding multiple light sources, thus, the cost of the optical transmitter is increased.

What is needed, therefore, is an optical transmitter module and an optical transmitting method that will overcome the above mentioned shortcomings

### BRIEF DESCRIPTION OF THE DRAWINGS

Many aspects of the present optical transmitter module can be better understood with reference to the following drawings. The components in the drawings are not necessarily drawn to scale, the emphasis instead being placed upon clearly illustrating the principles of the present optical transmitter module and optical transmitting method. Moreover, in the drawings, like reference numerals designate corresponding parts throughout the views.

FIG. 1 is a schematic view of an optical transmitter module of a first embodiment, the optical transmitter module including an optical modulator.

FIG. 2 is an optical spectral pattern produced by the optical modulator of FIG. 1.

FIG. 3 is a schematic view of an optical transmitter module of a second embodiment.

FIG. 4 is a schematic view of an optical transmitter module of a third embodiment.

FIG. 5 is a flow chart of an optical transmitting method of a fourth embodiment.

FIG. 6 is a flow chart of an optical transmitting method of a fifth embodiment.

### DETAILED DESCRIPTION

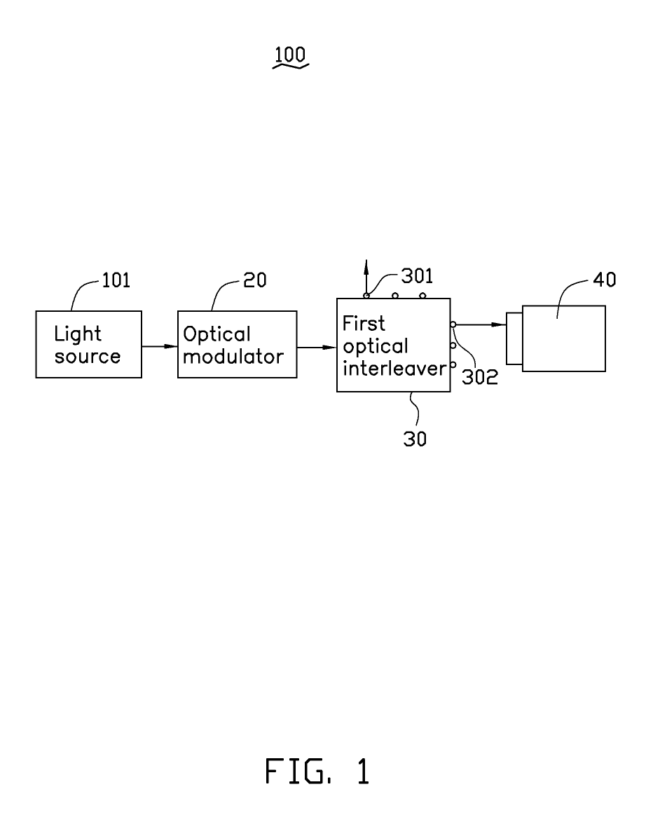

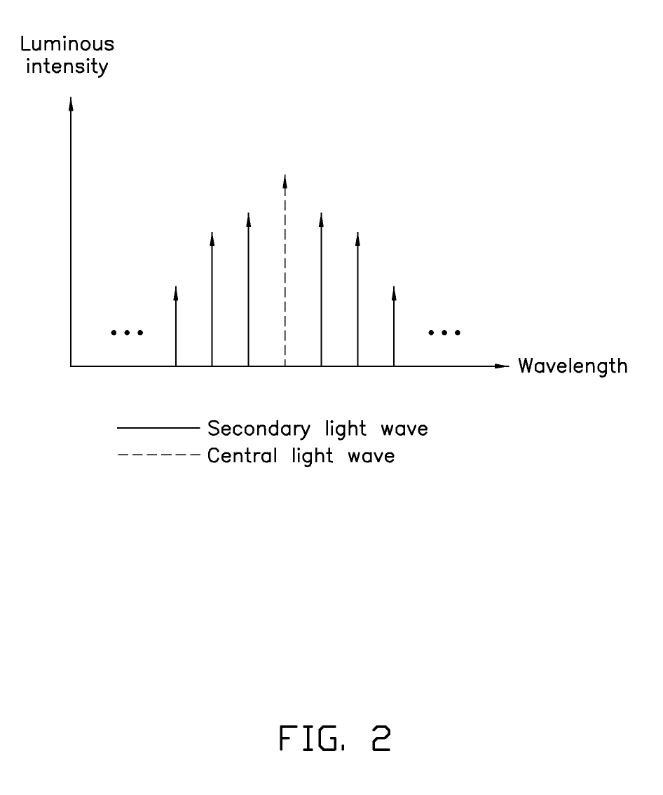

FIGS. 1 and 2, illustrate a first embodiment of an optical transmitter module 100. The optical transmitter module 100 is used for transmitting optical signals in an optical communication system. The optical transmitter module 100 includes a light source 101, an optical modulator 20, a first optical interleaver 30, and an optical fiber 40 connected in series.

In this embodiment, the light source 101 is a laser diode. The light source 101 provides continuous light wave which have a particular wavelength, for example, a wavelength of about 1510 nanometers (nm). Then the continuous light wave is modulated by the optical modulator 20. The optical modulator 20 modulates the phase of the continuous light wave, thus to form a central light wave having the particular wavelength, and a number of secondary light waves having a number of secondary wavelengths. In this embodiment, the wavelengths of the secondary light waves are in the range of 1505 nm to 1515 nm. Two to four of the second light signals are selected as carrier waves.

The first optical interleaver 30 is used for isolating the central light wave and the secondary light waves. The first optical interleaver 30 includes a number of odd ports 301 and a number of even ports 320. In this embodiment, as there is only one light source 101, thus, only one odd port 301 and only one even port 302 are used. The central light wave is output from the odd port 301. The secondary light waves are output from the even port 302. The optical fiber 40 is connected to the even port 302 and the secondary light waves are transmitted in the optical fiber 40 as the carrier waves. As there are at least two or four carrier waves transmitted in the optical fiber 40, the transmitting capacity of the optical transmitter module 100 is increased.

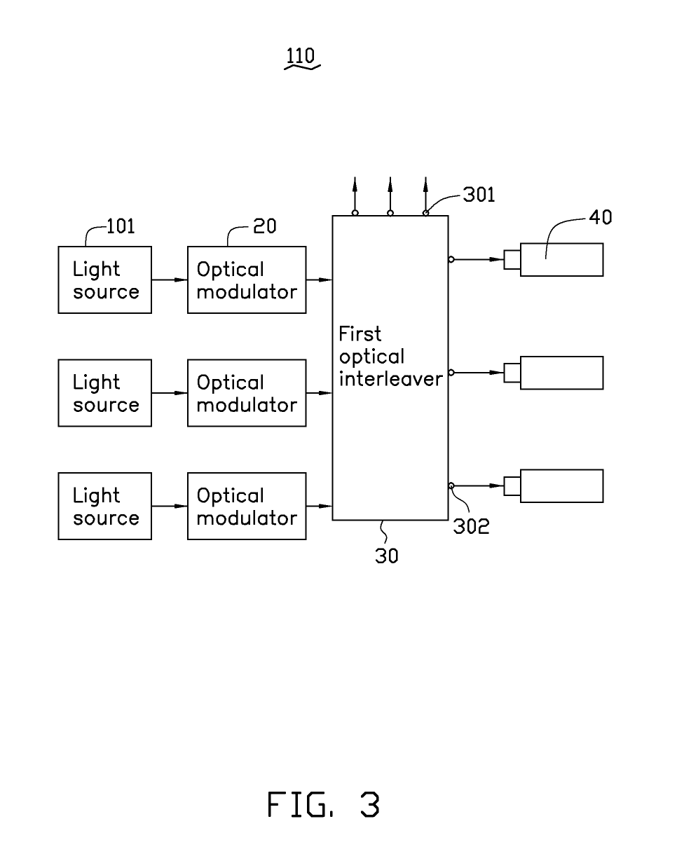

Referring to FIG. 3, an optical transmitter module 110 according to a second embodiment is disclosed. The optical transmitter module 110 includes three light sources 101, three optical modulators 20, the first optical interleaver 30, and three optical fibers 40. Each of the light sources 101 is connected to a corresponding optical modulator 20. The optical modulators 20 are connected to the first optical interleaver 30. Each of the light sources 101 corresponds to one odd port 301 and one even port 302. Each of the optical fibers 40 is connected to a corresponding even port 302. The three light sources 101 provide three continuous light waves which respectively have particular wavelengths of 1510 nm, 1535 nm, and 1560 nm. The three optical modulators 20 respectively modulate the three continuous light waves to three groups of light waves. Central light waves of the three groups of light waves are output from the odd ports 301. Secondary light waves of the three groups of light waves, which have wavelengths of 1508 nm, 1512 nm, 1533 nm, 1537 nm, 1558 nm, and 1562 nm, are output form the even ports 302 and are transmitted in the three optical fibers 40 as the carrier waves.

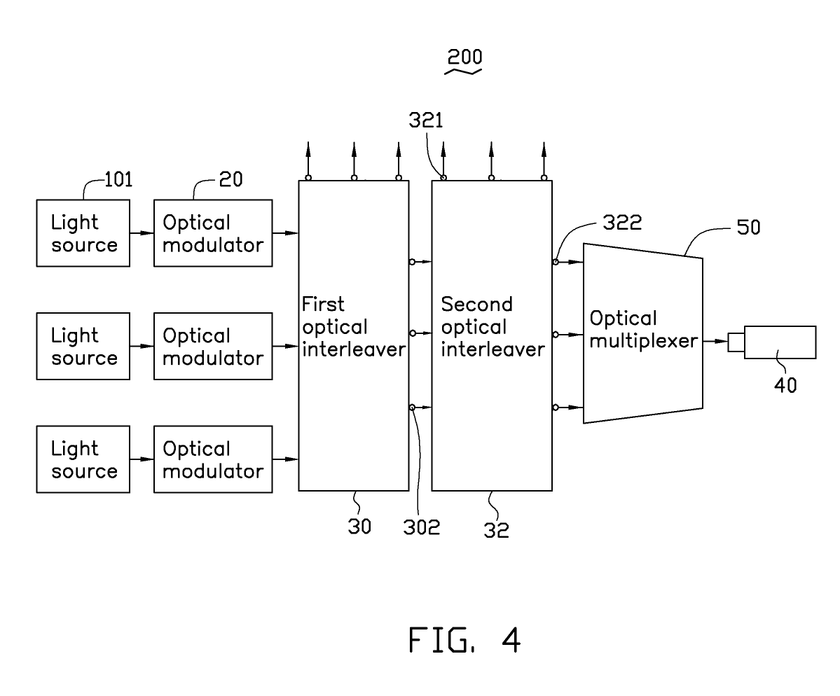

Referring to FIG. 4, an optical transmitter module 200 according to a third embodiment is disclosed. The optical transmitter module 200 is similar to the optical transmitter module 110 disclosed in FIG. 3, but varies by further including a second optical interleaver 32, an optical multiplexer 50, and for only including one optical fiber 40. The first optical interleaver 30, the second optical interleaver 32, the optical multiplexer 50, and the optical fiber 40 are connected in series. The second optical interleaver 32 includes a number of odd ports 321 and a number of even ports 322. The secondary optical waves which have wavelengths of 1508 nm, 1533 nm, and 1558 nm are output from the odd ports 321. The secondary waves which have wavelengths of 1512 nm, 1537 nm and 1562 nm are output from the even ports 322. The optical multiplexer 50 combines the secondary waves outputted from the even ports 322 to one carrier signal. The carrier signal is transmitted by the optical fiber 40. In this way, only one optical fiber 40 is needed.

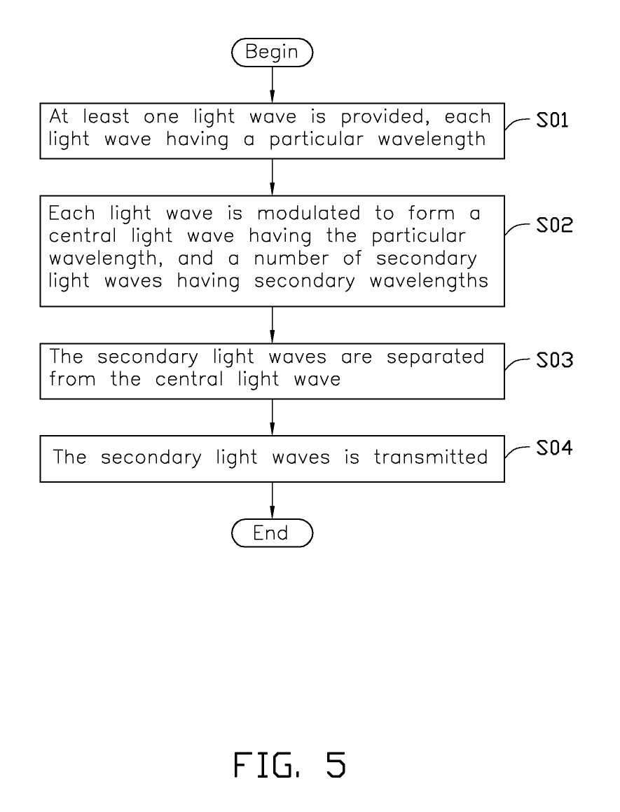

Referring to FIG. 5, an optical transmitting method according to a fourth embodiment is disclosed. The optical transmitting method is executed by the optical transmitter module 100 and the optical transmitter module 110. In step S01 of the method, at least one light wave is provided, each light wave has a particular wavelength. In the present embodiment, the light wave is provided by the light source 101. In step S02, each light wave is modulated to form a central light wave having the particular wavelength and a number of secondary light waves having secondary wavelengths. In this embodiment, the light wave is modulated by the optical modulator 20. In step S03, the secondary light waves are separated from the central light wave. In this embodiment, the separating equipment is the first optical interleaver 301. In step S04: the secondary light waves are transmitted. In this embodiment, the secondary light waves are transmitted by the optical fiber 40.

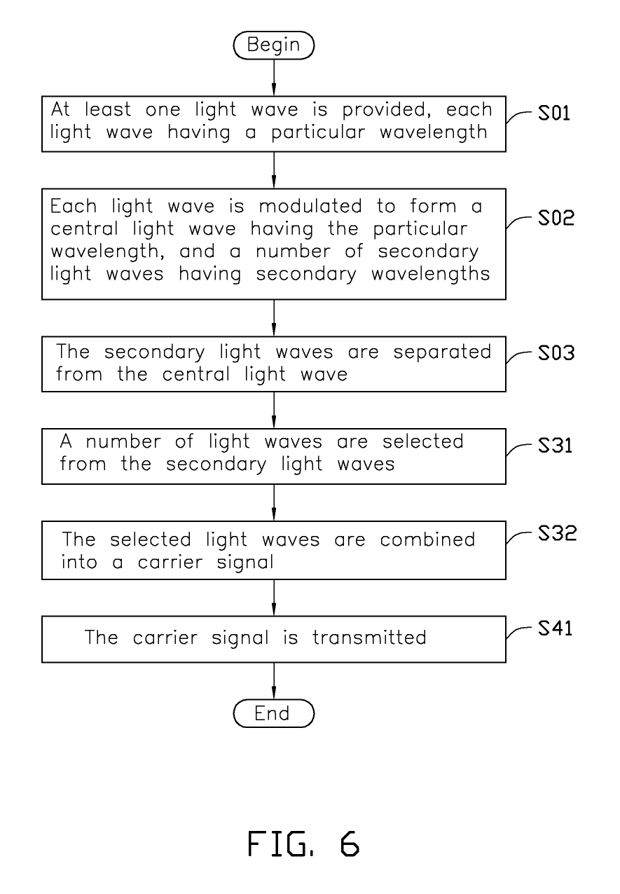

Referring to FIG. 6, an optical transmitting method according to a fifth embodiment is disclosed. The optical transmitting method of the present embodiment is executed by the optical transmitter module 200. The step 01 to step 03 of the present method is similar to step 01 to step 03 of the method showing in FIG. 5, thus, a detailed description is omitted here. In step S31, a number of light waves are selected from the secondary light waves. In this embodiment, the light waves are selected by the second optical interleaver 32. In step S32, the selected light waves are combined into a carrier signal. In this embodiment, the selected light waves are combined by the optical multiplexer 50. In step 41, the carrier signal is transmitted. In this embodiment, the carrier signal is transmitted by the optical signal 40.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. An optical transmitter module, comprising:
at least one light source, each light source emitting a light wave with a particular wavelength;
at least one optical modulator, each optical modulator aligning with a respective one of the at least one light source, each optical modulator modulating the light wave emitting from the respective light source, to form a central light wave having the particular wavelength and a number of secondary light waves having secondary wavelengths;
a first light interleaver for separating the secondary light waves from the central light wave; and
at least one optical fiber for transmitting the secondary light waves.

2. The optical transmitter module of claim 1, wherein each of the at least one light sources is a laser diode.

3. The optical transmitter module of claim 1, wherein the first light interleaver comprises a number of odd ports and a number of even ports, the central light wave is output from the odd ports, and the secondary light waves are output from the even ports.

4. The optical transmitter module of claim 1, further comprising a second light interleaver connected between the first interleaver and the at least one optical fiber, the second light interleaver being used for selecting a number of light waves from the secondary light waves.

5. The optical transmitter module of claim 4, wherein the number of the at least one optical fiber is one, and the optical transmitter module further comprises an optical multiplexer connected between the second light interleaver and the optical fiber, the optical multiplexer combines the number of light waves selected by the second light interleaver into a carrier signal which is transmitted by the optical fiber.

6. An optical transmitting method, comprising steps of:
providing at least one light wave, each light wave having a particular wavelength;
modulating each light wave to form a central light wave having the particular wavelength and a number of secondary light waves having secondary wavelengths;
separating the secondary light waves from the central light wave; and
transmitting the secondary light waves.

7. An optical transmitting method, comprising steps of:
providing at least one light wave, each light wave having a particular wavelength;
modulating each light wave to form a central light wave having the particular wavelength and a number of secondary light waves having secondary wavelengths;
separating the secondary light waves from the central light wave;
selecting a number of light waves from the secondary light waves;
combining the selected light waves into a carrier signal; and
transmitting the carrier signal.
